(19) United States
(12) Patent Application Publication
(10) Pub. No.: US 2013/0070259 A1
(43) Pub. Date: Mar. 21, 2013

(54) IMAGE PROCESSING APPARATUS, NON-TRANSITORY COMPUTER READABLE MEDIUM AND IMAGE PROCESSING METHOD

(71) Applicants: Masaomi SAKAMOTO, Kanagawa (JP); Makoto SASAKI, Kanagawa (JP); Masaru OKUTSU, Kanagawa (JP); Daigo HAMA, Kanagawa (JP)

(72) Inventors: Masaomi SAKAMOTO, Kanagawa (JP); Makoto SASAKI, Kanagawa (JP); Masaru OKUTSU, Kanagawa (JP); Daigo HAMA, Kanagawa (JP)

(73) Assignee: FUJI XEROX CO., LTD., Tokyo (JP)

(21) Appl. No.: 13/354,839

(22) Filed: Jan. 20, 2012

(30) Foreign Application Priority Data
Sep. 21, 2011 (JP) 2011-206616

(51) Int. Cl. G06K 15/02

(52) U.S. Cl. 358/1.2

(57) ABSTRACT

Provided is an image processing apparatus including a generation unit that generates an image with a resolution output to a first output device, a first correction unit that performs a spatial frequency correction for an output from the first output device on the image generated by the generation unit, a resolution conversion unit that converts a resolution of the image generated by the generation unit into a resolution of a second output device, and a second correction unit that performs a spatial frequency correction on an image converted by the resolution conversion unit so that a result of the spatial frequency correction performed in the first correction unit is visually obtained when an output from the second output device is performed.

### CROSS-REFERENCE TO RELATED APPLICATIONS

This application is based on and claims priority under 35 USC 119 from Japanese Patent Application No. 2011-206616 filed Sep. 21, 2011.

### BACKGROUND

(i) Technical Field

The present invention relates to an image processing apparatus, a non-transitory computer readable medium and an image processing method.

(ii) Related Art

In output apparatuses such as an image forming apparatus and the like, images or the like are output by performing drawing processing in accordance with given drawing information and performing various types of image processing including a spatial frequency correction. Since the characteristics of an image processing unit of the output apparatus are known, the spatial frequency correction may be uniformly performed in accordance with the characteristics thereof.

Before an image is formed and output by the output apparatus (referred to as a first output device), the image may be confirmed by outputting the image to another output apparatus (referred to as a second output device), for example, a display device or the like. When an image, generated in order to be output from the first output device, in which image processing is performed is output to the second output device, the enhanced spatial frequencies are different due to the difference in resolution between the first output device and the second output device, and thus the sense of sharpness changes.

### SUMMARY

According to an aspect of the invention, there is provided an image processing apparatus including:

a generation unit that generates an image with a resolution output to a first output device;

a first correction unit that performs a spatial frequency correction for an output from the first output device on the image generated by the generation unit;

a resolution conversion unit that converts a resolution of the image generated by the generation unit into a resolution of a second output device; and

a second correction unit that performs a spatial frequency correction on an image converted by the resolution conversion unit so that a result of the spatial frequency correction performed in the first correction unit is visually obtained when an output from the second output device is performed.

### BRIEF DESCRIPTION OF THE DRAWINGS

Exemplary embodiments of the present invention will be described in detail based on the following figures, wherein:

FIG. 1 is a configuration diagram illustrating an exemplary embodiment of the invention;

FIGS. 2A and 2B are explanatory diagrams illustrating an example of spatial frequency correction performed in a first correction unit and a second correction unit;

FIG. 3 is a configuration diagram illustrating a modified example in the exemplary embodiment of the invention; and

FIG. 4 is an explanatory diagram illustrating an example of a computer program when functions described in the exemplary embodiment of the invention or the modified example thereof are realized by a computer program, a recording medium having the computer program stored thereon, and a computer.

### DETAILED DESCRIPTION

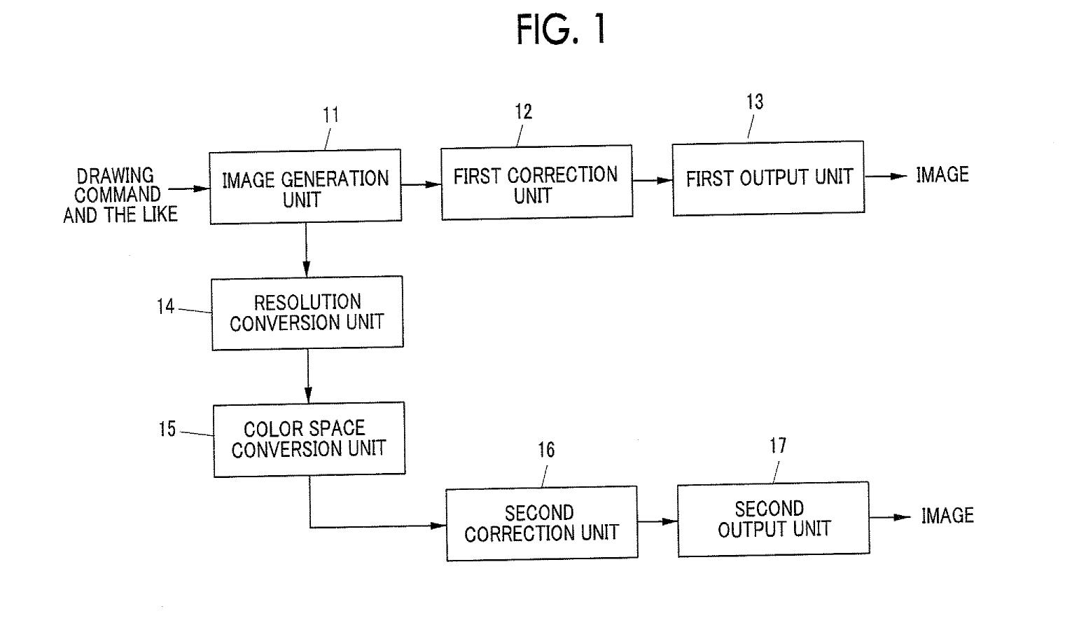

FIG. 1 is a configuration diagram illustrating an exemplary embodiment of the invention. In the drawing, 11 denotes an image generation unit, 12 denotes a first correction unit, 13 denotes a first output unit, 14 denotes a resolution conversion unit, 15 denotes a color space conversion unit, 16 denotes a second correction unit, and 17 denotes a second output unit.

The image generation unit 11 generates an image with a resolution output to the first output unit 13. For example, the image generation unit generates a raster image by receiving a drawing command which contains a photographic image and the like to perform drawing processing. Various processing such as color conversion or data format conversion may be performed at the time of the drawing processing.

The first correction unit 12 performs a spatial frequency correction for the output from the first output unit 13 on the image generated by the image generation unit 11. Processing of the spatial frequency correction may be performed, for example, by filtering, and the coefficient or the size of a filter may be adjusted with respect to the enhanced frequency or strength. Meanwhile, the strength of the correction may be changed in accordance with the instructions from the outside. The instructions may be performed by a user in, for example, a setting unit (not shown) and the like.

The first output unit 13 outputs the image in which the spatial frequency correction is performed by the first correction unit 12. For example, the first output unit may be a device that forms an image on a medium such as a piece of paper or an object using a color material such as toner or ink, or may be a display device or the like that displays an image.

When the image generated in order to perform the output from the image generation unit 11 to the first output unit 13 is output by the second output unit 17, the resolution conversion unit 14 converts the resolution of the image generated by the image generation unit 11 into the resolution of the second output unit 17. As a method of the resolution conversion, various methods hitherto known may be used.

When color spaces handled by the first output unit 13 and the second output unit 17 are different from each other, the color space conversion unit 15 performs conversion from the color space handled by the first output unit 13 to the color space handled by the second output unit 17. Of course, when the color spaces are not different from each other, the color space conversion unit 15 may not be provided. In addition, the color conversion using the color space conversion unit 15 may be performed before the resolution conversion unit 14.

The second correction unit 16 performs the spatial frequency correction on the image converted by the resolution conversion unit 14 so that the result of the spatial frequency correction, performed by the first correction unit 12, which appears in the image output from the first output unit 13 is visually obtained even when an image is output from the second output unit 17. The processing of the spatial frequency correction may be performed by, for example, filtering, and the enhanced frequency or strength may visually conform to the result of the image output from the first output unit 13 by changing the coefficient or the size of a filter. Meanwhile, when the strength of the correction in the first correction unit 12 is changed in accordance with the instructions from the outside, the changed strength also corresponds to a change in the strength in the second correction unit 16. In addition, when the ratio of the resolution of the first output unit 13 to the resolution of the second output unit 17 exceeds a predetermined range, the resolution conversion processing using the resolution conversion unit 14 and the color space conversion processing using the color space conversion unit 15 may be performed on the image in which the spatial frequency correction is performed by the first correction unit 12 to transfer the resultant image to the second output unit 17, or the spatial frequency correction performed by the first correction unit 12 may be performed by the second correction unit 16.

The second output unit 17 is an output device having a resolution different from that of the first output unit 13, and outputs the image in which the spatial frequency correction is performed by the second correction unit 16. For example, the second output unit may be a display device, or may be an image forming device or the like that forms an image on a medium such as a piece of paper or an object using a color material such as toner or ink.

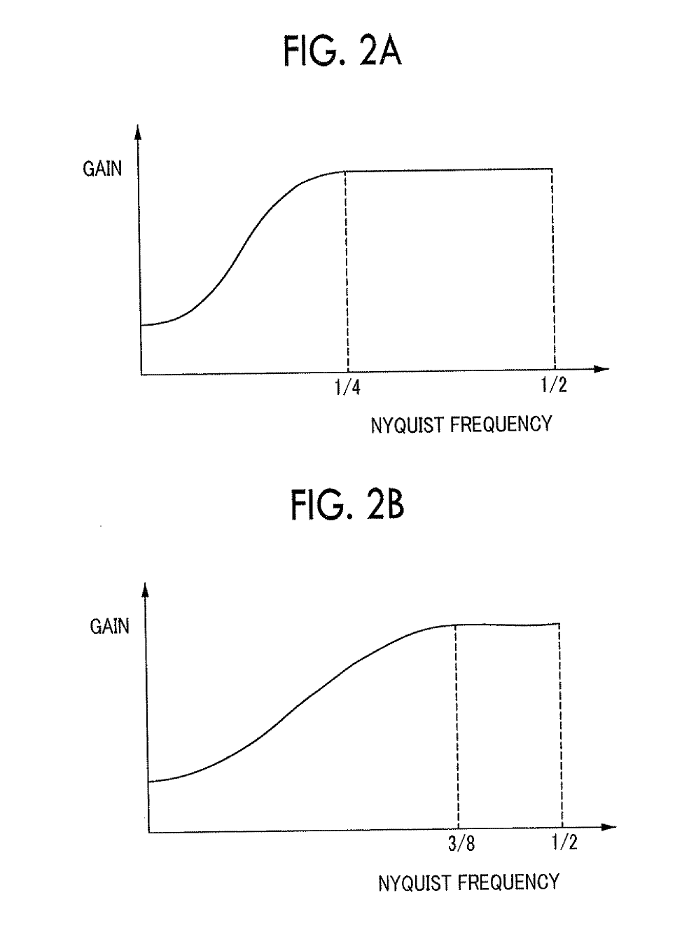

The second correction unit 16 will be further described. FIGS. 2A and 2B are explanatory diagrams illustrating an example of the spatial frequency correction performed in the first correction unit and the second correction unit. Specifically, the resolution of the first output unit 13 is set to 300 dpi, and the resolution of the second output unit 17 is set to 200 dpi. In addition, in the first correction unit 12, the spatial frequency correction is performed by a filter having a frequency characteristic shown in FIG. 2A. In the filter in the example shown in FIG. 2A, the Nyquist frequency is enhanced in the frequency of 1/4 or higher. Therefore, in the resolution, the frequency component equivalent to or more than 300×1/4=75 dpi is enhanced.

In the image generation unit 11, the resolution of the first output unit 13 is 300 dpi and thus the image of 300 dpi is generated. When the image is output to the first output unit 13, the spatial frequency correction is performed in the first correction unit 12 by the filter having a frequency characteristic shown in FIG. 2A, and the corrected image is output from the first output unit 13.

When the image output from the first output unit 13 is output (output at the same magnification) from the second output unit 17 by conversion into the resolution of the second output unit 17 (conversion from 300 dpi to 200 dpi in this example) and color space conversion, the sharpness or the enhanced frequency band and the like change due to the resolution conversion and the color space conversion. For this reason, the output from the second output unit 17 is visually different from the output from the first output unit 13.

When an image generated with a resolution (300 dpi in this example) output from the first output unit 13 is output from the second output unit 17 in the image generation unit 11, the resolution of the image is converted (converted from 300 dpi to 200 dpi in this example) into a resolution of the second output unit 17 in the resolution conversion unit 14, and the color space conversion of the image is further performed in the color space conversion unit 15. After that, the spatial frequency correction is performed on the converted image in the second correction unit 16. When the output thereof from the first output unit 13 is performed, the frequency component equivalent to or more than 75 dpi is enhanced by the first correction unit 12, and thus the frequency component equivalent to or more than 75 dpi is also enhanced in the second correction unit 16 with respect to the image after the resolution conversion. The frequency characteristic of a filter used when the spatial frequency correction is performed in the second correction unit 16 in this case is shown in FIG. 2B. In the filter in the example shown in FIG. 2B, the Nyquist frequency is enhanced in the frequency of 3/8 or higher. Therefore, since the resolution of the second output unit 17 is set to 200 dpi, the frequency component equivalent to or more than 200×3/8=75 dpi is enhanced. This is a frequency characteristic of the spatial frequency correction performed at the time of performing the output from the first output unit 13. In this manner, the enhancement result performed on the image output from the first output unit 13 is visually obtained in the image output from the second output unit 17.

An example is shown in which the frequency characteristics at the time of enhancing the images output from the first output unit 13 and the second output unit 17 are matched with each other in this example. However, a filter in which the spatial frequency correction of the second correction unit 16 is performed may be designed in consideration of, for example, the difference in the output method (for example, displaying or printing, a method of displaying or printing, and the like), an aspect of observing the output image (for example, observing reflected light or observing emitted light, and the like), and various other conditions, in addition to the frequency characteristic.

When the spatial frequency correction is performed and then the processing such as the resolution conversion or the color space conversion is performed as mentioned above, the sharpness or the enhanced frequency band and the like change by the processing. However, when the spatial frequency correction is performed after the resolution conversion and the color space conversion, the sharpness or the enhanced frequency band and the like do not change.

Even when the device used as the second output unit 17 is changed, the coefficient of a filter for use in the spatial frequency correction in the second correction unit 16 may be changed in accordance with the resolution or other characteristics of the device used as the second output unit 17. An image in which the result of the spatial frequency correction in the image output from the first output unit 13 is reflected is output corresponding to various devices.

Meanwhile, the filter used in the spatial frequency correction is prepared for each color component constituting a color space used by the second output unit 17. For example, when the color space is an RGB color space, a filter corresponding to each of the color components of R, G, and B may be prepared. Alternatively, the color space may be converted into a color space having a luminance axis to perform filtering on the brightness, and may be converted into the color space used by the second output unit 17 again. For example, the RGB color space may be converted into a YCrCb color space to perform filtering on a Y component, and may be converted into the RGB color space again.

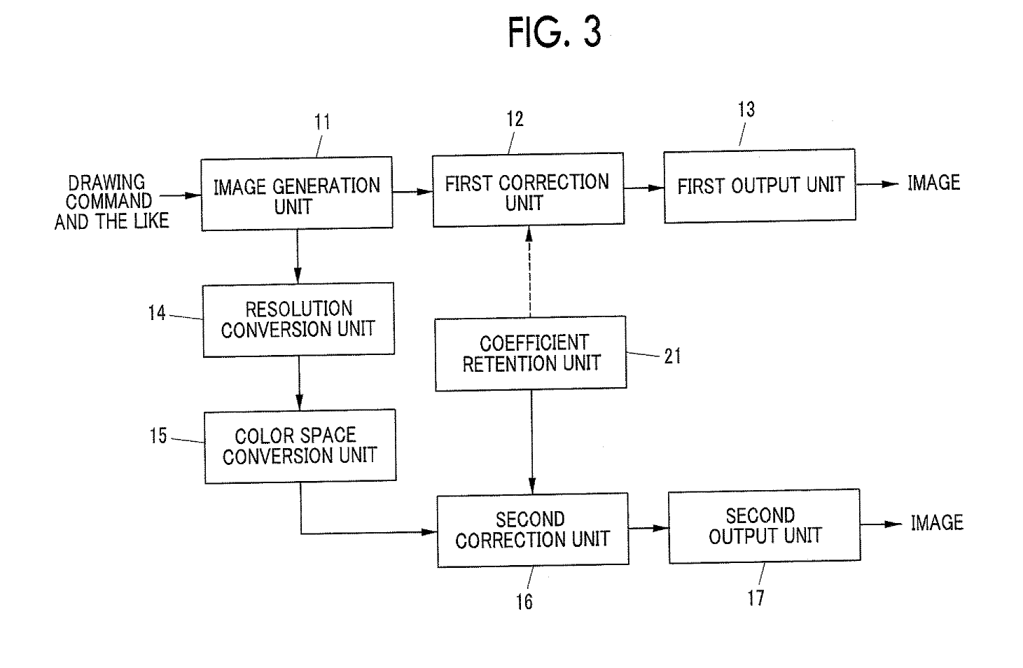

FIG. 3 is a configuration diagram illustrating a modified example of an exemplary embodiment of the invention. In the drawing, 21 denotes a coefficient retention unit. When the characteristic of the spatial frequency correction using the first correction unit 12 is determined, the coefficient (spatial frequency correction coefficient) used when the spatial frequency correction is performed in the second correction unit 16 may be calculated corresponding to the resolution or other characteristics of the second output unit 17. In addition, for example, when the strength of the spatial frequency correction using the first correction unit 12 is changed, the coefficient based on the strength thereof is calculated. Although this coefficient may be calculated whenever the first output unit 13 and the second output unit 17 are determined, an example in which the coefficient is previously calculated is shown in the modified example.

The coefficient retention unit 21 retains at least plural coefficients (spatial frequency correction coefficients) used when the spatial frequency correction is performed in the second correction unit 16. Each of the coefficients is previously calculated for each resolution or characteristic of the second output unit 17.

In the second correction unit 16, a coefficient based on the resolution of the second output unit 17 is selected and acquired from plural coefficients retained in the coefficient retention unit 21, and the spatial frequency correction is performed using the acquired coefficient. The resolution or the characteristics and the like of the second output unit 17 may be acquired from the second output unit 17, acquired by performing an inquiry to the outside, instructed along with a drawing command transferred to the image generation unit 11, or set in a setting unit (not shown) by a user. Of course, a coefficient is selected and acquired by further adding various elements such as the output characteristics or the output method of the second output unit 17 in addition to the resolution of the second output unit 17, and the spatial frequency correction may be performed using the coefficient.

Meanwhile, the coefficient used when the spatial frequency correction is performed in the first correction unit 12 may also be retained in the coefficient retention unit 21, corresponding to a case in which the frequency band or the strength of the spatial frequency correction in the first correction unit 12 is changed. In that case, the coefficient corresponding to each of the strengths or the frequency bands used in the first correction unit 12 and plural coefficients corresponding to the resolution or the output characteristics and the like of the second output unit 17 used in the second correction unit 16 may be retained in association with each other. When the frequency band or the strength of the spatial frequency correction and the like performed at the time of the output to the first output unit 13 are set, a coefficient is selected and acquired by the set correction strength or frequency band for the first correction unit 12 and the resolution or the output characteristics and the like of the second output unit 17, and may be output from the second output unit 17 by performing the spatial frequency correction using the coefficient. When the output to the first output unit 13 is performed, the coefficient corresponding to the set correction strength or frequency band is acquired by the first correction unit 12, and may be output from the first output unit 13 by performing the spatial frequency correction. The frequency band or the strength of the spatial frequency correction and the like in the first correction unit 12 may be instructed along with a drawing command transferred to the image generation unit 11, including whether to perform the spatial frequency correction, or may be set in a setting unit (not shown) by a user.

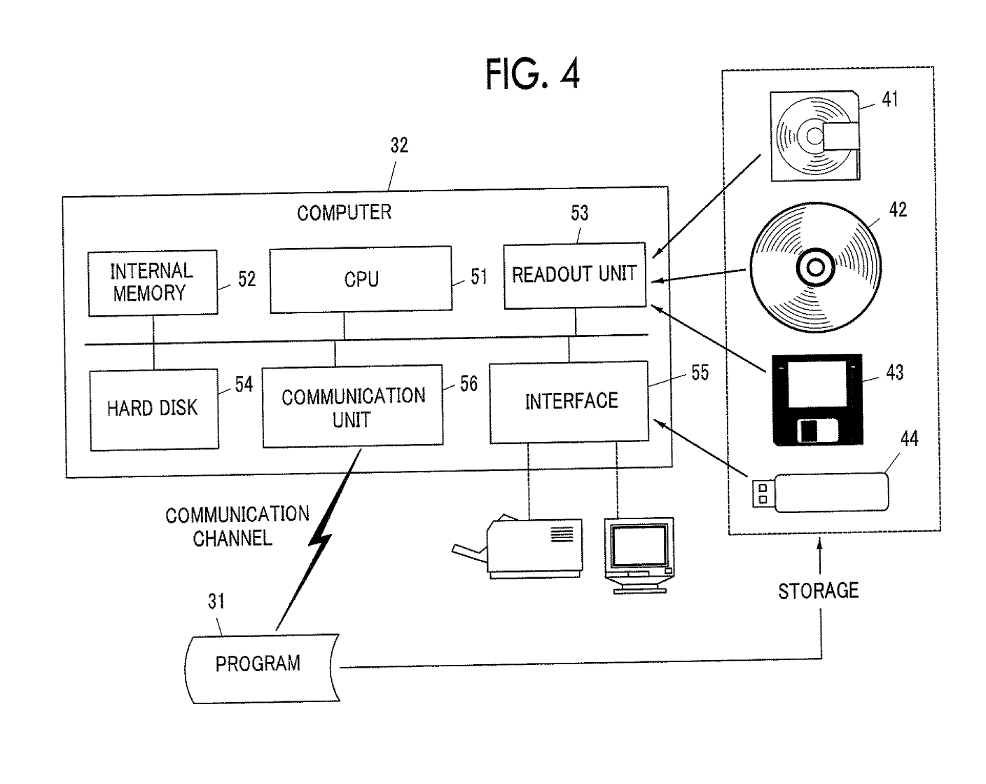

FIG. 4 is an explanatory diagram illustrating an example of a computer program when functions described in the exemplary embodiment of the invention or the modified example thereof are realized by a computer program, a recording medium having the computer program stored thereon, and a computer. In the drawing, 31 denotes a program, 32 denotes a computer, 41 denotes a magneto-optical disk, 42 denotes an optical disk, 43 denotes a magnetic disk, 44 denotes a memory, 51 denotes a CPU, 52 denotes an internal memory, 53 denotes a readout unit, 54 denotes a hard disk, 55 denotes an interface, and 56 denotes a communication unit.

The function of each of the units described in the exemplary embodiment or the modified example of the invention mentioned above may be entirely or partially realized by the program 31 for causing a computer to execute the function. In that case, the program 31, data used by the program and the like may be stored in a recording medium read out by a computer. The recording medium is a medium that causes change states of magnetic, optical, and electrical energy or the like in response to the content description of a program with respect to the readout unit 53 included in hardware resources of a computer, and transfers the content description of a program to the readout unit 53 in the form of signals corresponding thereto. For example, the recording medium includes the magneto-optical disk 41, the optical disk 42 (including a CD, a DVD and the like), the magnetic disk 43, the memory 44 (including an IC card, a memory card, a flash memory and the like) and the like. Of course, the recording medium is not limited to a portable type.

When the program 31 is stored in such a recording medium, the program 31 is read out from a computer, for example, by mounting the recording medium in the readout unit 53 or the interface 55 of the computer 32 and is stored in the internal memory 52 or the hard disk 54 (including a magnetic disk or a silicon disk and the like), and the function described in the exemplary embodiment or the modified example of the invention mentioned above is all or partially realized by executing the program 31 using the CPU 51. Alternatively, the program 31 is transferred to the computer 32 through a transmission channel, the program 31 is received in the communication unit 56 of the computer 32 and is stored in the internal memory 52 or the hard disk 54, and the above-mentioned function may be realized by executing the program 31 using the CPU 51.

The computer 32 may be connected to various devices through another interface 55. For example, the first output unit 13 or the second output unit 17 may be connected through the interface 55. Of course, the configuration may be partially configured by hardware, and may be entirely configured by hardware. Alternatively, the configuration may be configured as a program including all or a portion of the functions described in the exemplary embodiment or the modified example of the invention along with another configuration. Even when the configuration is applied to another application, it may be integrated with a program in the application.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a generation unit that generates an image with a resolution output to a first output device;
a first correction unit that performs a spatial frequency correction for an output from the first output device on the image generated by the generation unit;
a resolution conversion unit that converts a resolution of the image generated by the generation unit into a resolution of a second output device; and
a second correction unit that performs a spatial frequency correction on an image converted by the resolution conversion unit so that a result of the spatial frequency correction performed in the first correction unit is visually obtained when an output from the second output device is performed.

2. The image processing apparatus according to claim 1, further comprising:
a retention unit that retains a plurality of spatial frequency correction coefficients,
wherein the second correction unit acquires a spatial frequency correction coefficient based on the resolution of the second output device from the retention unit to perform a spatial frequency correction.

3. The image processing apparatus according to claim 1, wherein the second correction unit determines a correction characteristic based on a correction characteristic in the first correction unit and the resolution of the second output device to calculate a spatial frequency correction coefficient and performs a spatial frequency correction using the spatial frequency correction coefficient.

4. The image processing apparatus according to claim 1, wherein the first correction unit performs a spatial frequency correction in response to instructions of a given strength, and
the second correction unit performs a spatial frequency correction based on a strength of the spatial frequency correction performed in the first correction unit on the image converted by the resolution conversion unit.

5. The image processing apparatus according to claim 2, wherein the first correction unit performs a spatial frequency correction in response to instructions of a given strength, and the second correction unit performs a spatial frequency correction based on a strength of the spatial frequency correction performed in the first correction unit on the image converted by the resolution conversion unit.

6. The image processing apparatus according to claim 3, wherein the first correction unit performs a spatial frequency correction in response to instructions of a given strength, and the second correction unit performs a spatial frequency correction based on a strength of the spatial frequency correction performed in the first correction unit on the image converted by the resolution conversion unit.

7. The image processing apparatus according to claim 1, wherein the image generated by the generation unit is corrected by the second correction unit after color conversion processing is performed.

8. The image processing apparatus according to claim 2, wherein the image generated by the generation unit is corrected by the second correction unit after color conversion processing is performed.

9. The image processing apparatus according to claim 3, wherein the image generated by the generation unit is corrected by the second correction unit after color conversion processing is performed.

10. The image processing apparatus according to claim 4, wherein the image generated by the generation unit is corrected by the second correction unit after color conversion processing is performed.

11. The image processing apparatus according to claim 5, wherein the image generated by the generation unit is corrected by the second correction unit after color conversion processing is performed.

12. The image processing apparatus according to claim 6, wherein the image generated by the generation unit is corrected by the second correction unit after color conversion processing is performed.

13. A non-transitory computer readable medium storing a program causing a computer to execute a function of the image processing apparatus according to claim 1.

14. An image processing method comprising:
generating an image with a resolution output to a first output device;
performing a spatial frequency correction for an output from the first output device on the image generated in the generating of the image;
converting a resolution of the image generated in the generating of the image into a resolution of a second output device; and
performing a spatial frequency correction on an image converted in the converting of the resolution so that a result of the spatial frequency correction performed in the performing of the spatial frequency correction is visually obtained when an output from the second output device is performed.
